(19) United States
(12) Patent Application Publication
(10) Pub. No.: US 2005/0207491 A1
(43) Pub. Date: Sep. 22, 2005

(54) Estimating motion trials in video image sequences

(76) Inventors: Bin Zhang, Fremont, CA (US); Fereydoon Safai, Los Altos Hills, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/802,428

(22) Filed: Mar. 17, 2004

(51) Int. Cl. H04N 7/12

(52) U.S. Cl. 375/240.16

(57) ABSTRACT

A method, apparatus and program storage device for estimating motion trials in video image sequences is described. Regression clustering may be performed by selecting a number of regression clusters, K, for data points from an image sequence. Regression functions for each of the K clusters are initialized to estimate the centers of motion for the data points.

### FIELD OF THE INVENTION

This disclosure relates in general to estimating motion trials in video image sequences.

### BACKGROUND

Recent advances in digital technology have led to new communication media in which video information plays a significant role. Digital television, high definition TV (HDTV), video-conferencing, video-telephony, medical imaging, and multi-media are but a few examples of emerging video information applications.

When compared with text or audio media, video media require a much larger bandwidth, and therefore would benefit more from compressing data having redundancies. In the framework of video coding (encoding and decoding), statistical redundancies can be characterized as spatial or temporal. Due to differences in the spatial and temporal dimensions, the compressing of the data is usually handled separately.

Motion of an object is a prominent source of temporal variations in image sequences. In order to model and compute motion, an understanding is needed as to how images (and therefore image motion) are formed. In video compression, the knowledge of motion helps remove temporal data redundancy and therefore attain high compression ratios. Motion estimation is a fundamental component of such standards as H.261, H.263 and the MPEG family.

A moving object may be characterized by coherent motion characteristics over its entire region of support. Therefore, an accurate estimate of the motion facilitates an accurate segmentation of the object. The process of partitioning frames into motion regions is referred to as image segmentation. Efficient image detection and segmentation operations need to be used to divide the image contents into semantic regions that can be dealt with as separate objects. An accurate segmentation of the object is needed in order to estimate the motion accurately. Image segmentation may include block-based, region-based or pixel-based image segmentation. Segmentation sometimes depends upon the results of motion estimation. Motion estimation basically tries to predict the current frame from the previous one by estimating the motion between the two frames. Hence, the motion and prediction error information are transmitted instead of the image itself.

While there are number of standards for video coding, e.g., MPEG-1, MPEG-2, MPEG-4, and H.263, etc, these standards only define the syntax and semantic of the compressed bit stream. The methods used to produce the bitstream are not specified. In other words, the above standards specify how the bitstream should appear so that decoders will operate properly, but do not specify the details of how the bitstream is actually produced.

Most standard operations, such as MPEG-1, MPEG-2, MPEG-4, and H.263, etc, use block-based segmentation. With block-based segmentation, the optical flow or “motion” of the pixels in the blocks is analyzed to estimate motion information. Compression is achieved, for example, by sending a block once, and then sending the motion information that indicates how the block “moves” in following frames. The efficiency of block-based video compression relies on its ability to predict the next frame using blocks of image elements, which is a method known as block-based “motion compensation.” Accurate prediction reduces the amount of data used to correct errors made by frame-to-frame prediction (residue coding). Over the years, refinements in motion compensation and residue coding techniques have played a major role in improving prediction in block-based compressors. However, these approaches have long-since exhausted their potential for further dramatic improvements. This is because arbitrary blocks, inherent in MPEG-like coding, rarely occur in natural images, and thus have no relationship to the real objects and their motion.

Unlike block-matching operations, which may require costly searches for image displacement, other compression techniques have been developed that approach image displacement using estimation techniques. Two techniques involve regression on the datasets with response variables chosen, and clustering on the datasets that do not have response information. Regression is merely a method for finding dependency between some attributes, e.g., motion vectors. Basically, regression takes a numerical dataset and develops a mathematical formula that fits the data. The results may then be used to predict future behavior by taking new data and plugging it into the developed formula thereby resulting in a prediction. Robust regression methods have been shown to provide some improvements in motion estimates in a variety of situations. For example, based on the motion data for a frame n, the scores and residual vector can be estimated using a number of different regression estimation methods.

Clustering is used to reveal the structure within complex distribution of data, for example, video media. Cluster analysis is a classification of objects from the data. Classification involves a labeling of objects with class (group) labels. As such, clustering does not use previously assigned class labels, except perhaps for verification of how well the clustering worked. Thus, cluster analysis is distinct from pattern recognition or the area of statistics know as discriminant analysis and decision analysis, which seek to find rules for classifying objects given a set of pre-classified objects.

For example, data clustering may be used to partition a data set into groups of similar items, as measured by some distance metric. Dissimilarity is labeled by the index of the partitions, which provide additional supervision to the K regressions so that each works on a subset of similar data. The similarity, or rather the dissimilarity, is provided by the K regressions and used in the clustering phase to partition the dataset.

The Regression Clustering (RC) operation handles the case in between regression and clustering operations, i.e., the datasets that have response variables, but the response variables do not contain enough information to guarantee high quality learning. Missing information is generally caused by insufficiently controlled data collection due to lack of means, lack of understanding or other reasons.

Regression Clustering provides an advantage because without separating the clusters with very different response properties, the residue error of the regression is large. Input variable selection could also be misguided to a higher complexity by the mixture. In RC, K (>1) regression functions are applied to the dataset simultaneously, which guide the clustering of the dataset into K subsets each with a simpler distribution matching its guiding function. Each function is regressed on its own subset of data with a much smaller residue error. Both the regressions and the clustering optimize a common objective function.

Regression clustering has been studied under a number of different names. For example, clusterwise linear regression uses linear regression and partition of the dataset to locally minimize the total mean square error over all K-regression. An incremental version of this operation was developed to allow adding new observations into the dataset. This operation is similar to the K-Means operation. The K-Means (KM) operation is a popular operation, which attempts to find a K-clustering, which minimizes MSE. The K-Means operation is a clustering operation that involves a two-step iteration. First, each data item is assigned to the closest center. All centers are recalculated and each center is moved to the geometric centroid of the points assigned to it. Alternative methods for performing clusterwise linear regression have also been proposed. For example, the maximum likelihood methodology has also been used for performing clusterwise linear regression, wherein the objective function is locally minimized.

However, all of the above clustering operations have disadvantages. For example, the dependency of the K-Means performance on the initialization of the centers is a major problem. Moreover, previous regression clustering methods have exhibited the same problem with the convergence being sensitive to initialization. For example, previous work on RC used K-Means and expectation-maximization (EM) demonstrated the same problem of their convergence being sensitive to initialization. The present invention may address one or more of the above issues.

### SUMMARY

The various embodiments of the present invention estimate motion trials in video image sequences using regression clustering operations that may be less sensitive to initialization of the center choices. The various embodiments include a method, apparatus and program storage device. Data points representing information from an image sequence are provided and regression clustering using K-Harmonic Means functions is performed to cluster the data points and to provide motion information for the data points.

### BRIEF DESCRIPTION OF THE DRAWINGS

Referring now to the drawings in which like reference numbers represent corresponding parts throughout:

FIG. 1 illustrates a video frame according to various embodiments of the present invention;

FIG. 2 illustrates a video sequence according to various embodiments of the present invention;

FIG. 3 illustrates a motion vector field according to various embodiments of the present invention;

FIG. 4A shows a video frame with a moving image area according to various embodiments of the present invention;

FIG. 4B shows a motion vector field generated from the frames of FIG. 4A;

FIG. 5 illustrates a system for simultaneously estimating multiple motion trials in video image sequences according to various embodiments of the present invention;

FIG. 6 is a dataflow diagram of a video compression system according to various embodiments of the present invention;

FIG. 7 illustrates two graphs showing a comparison between single function regression and three regression functions;

FIG. 8 is a flow chart of the operations for simultaneously estimating multiple motion trials in video image sequences according to various embodiments of the present invention;

FIG. 9 is a flow chart of the operations for preparing the data for processing according to various embodiments of the present invention; and

FIG. 10 illustrates additional operations when the changes on the membership probabilities or on the K functions are smaller than a chosen threshold according to various embodiments of the present invention.

### DETAILED DESCRIPTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The embodiments of the present invention provide a method, apparatus and program storage device for estimating motion trials in video image sequences. Embodiments of the present invention use regression clustering operations that may be far less sensitive to initialization of the center choices.

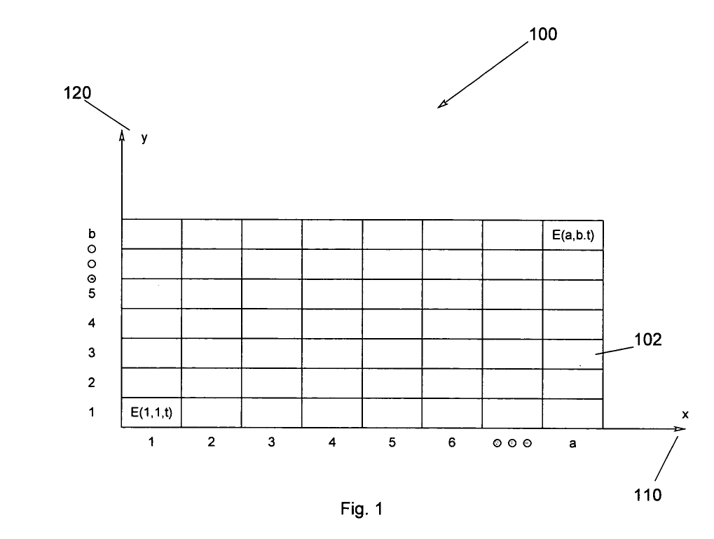

FIG. 1 illustrates a video frame 100 according to various embodiments of the present invention. Each rectangle portion 102 corresponds to a respectively different image component, which may be a pixel or group of pixels. The components may be referenced by x 110 and y 112 values respectively. Each component may have a value that could be represented by an intensity value E(x, y, t) in the image plane at time t. The horizontal location is represented by ‘x’ and may be numbered between 1 and a maximum value illustrated in this example as “a.” The vertical location is represented by ‘y’ and may be numbered between 1 and a maximum value as illustrated here as “b”. Time is represented as “t.”

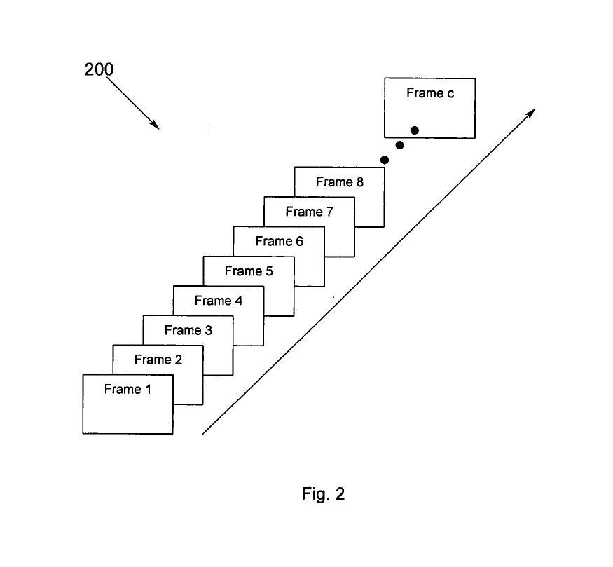

FIG. 2 illustrates a video sequence 200 according to various embodiments of the present invention. In FIG. 2, the video sequence 200 includes a series of successive video frames, i.e., Frame 1 to Frame c. Each frame is shown sequentially as time ‘t’ increases. To perform motion estimation, motion may be analyzed between a series of adjacent frames in a chosen window. The window size and the number of frames in the window can be either fixed or adaptive.

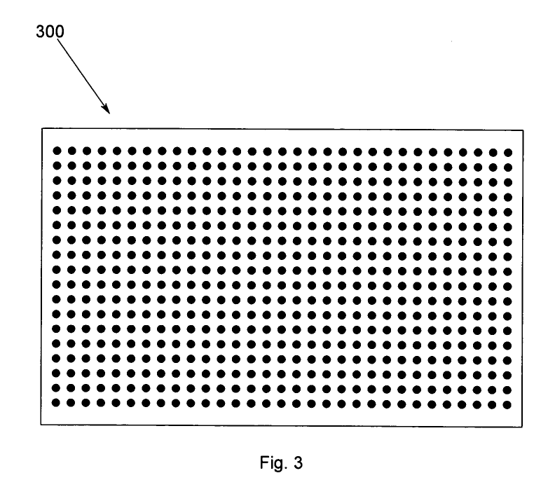

FIG. 3 illustrates a motion vector field 300 according to various embodiments of the present invention. In FIG. 3, the motion vector field 300 shows that there is no motion between two successive frames. In this motion vector field 300, all motion vector elements are zero.

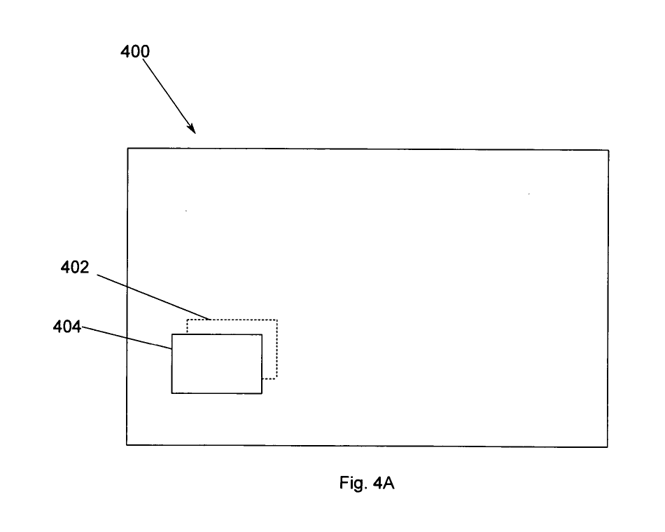

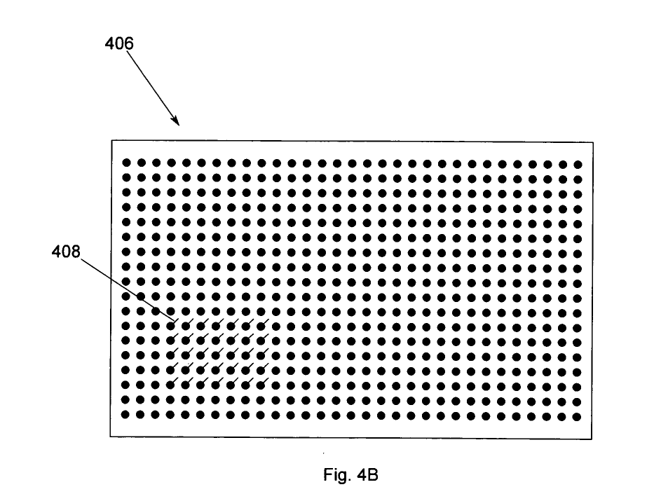

FIG. 4A shows a video frame 400 with a moving image area according to various embodiments of the present invention. In FIG. 4A, a central image area 404 moves to a new position 402, as indicated by the broken-line. The movement of the image area 404 to position 402 shows movement between a current frame and a next frame.

FIG. 4B shows a motion vector field 406 generated from the frames 404, 402 of FIG. 4A. A motion vector 408 is provided for each pixel in the image area 404 that moved to position 402 in FIG. 4A. The motion vector 408 shows the direction of the motion.

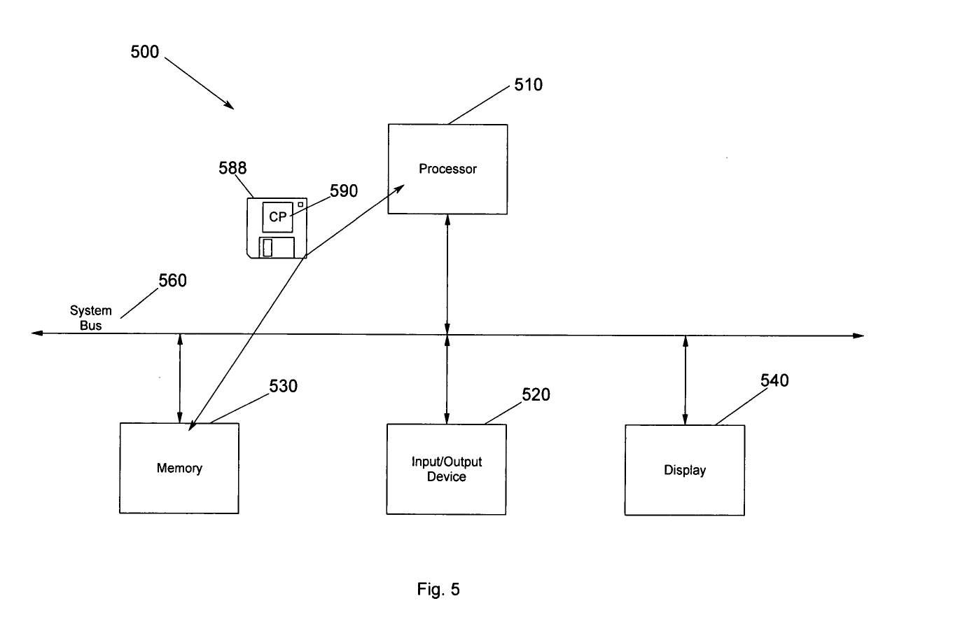

FIG. 5 illustrates a system 500 for simultaneously estimating multiple motion trials in video image sequences according to various embodiments of the present invention. As shown in FIG. 5, a processor 510 is connected to at least one input/output (I/O) device 520 via any suitable data connection. I/O device 520 can be any device capable of passing information to or receiving data from processor 510. By way of example only, I/O device 520 may be a video device coupled via an IEEE 1394 interface. Processor 510 may be any commonly available digital processor. Processor 510 may be a single processor or multiple processors. Faster processors, however, will decrease execution time of the invention. Moreover, special purpose processors optimized for image data processing may also be used.

The system 500 also includes memory 530 capable of storing data processed by processor 510 and data sent to or received from I/O device 520. System 500 may be connected to a display 540, such as a cathode ray tube (CRT), for displaying information. Processor 510, I/O device 520, memory 530, and display 540 are connected via a bus 560.

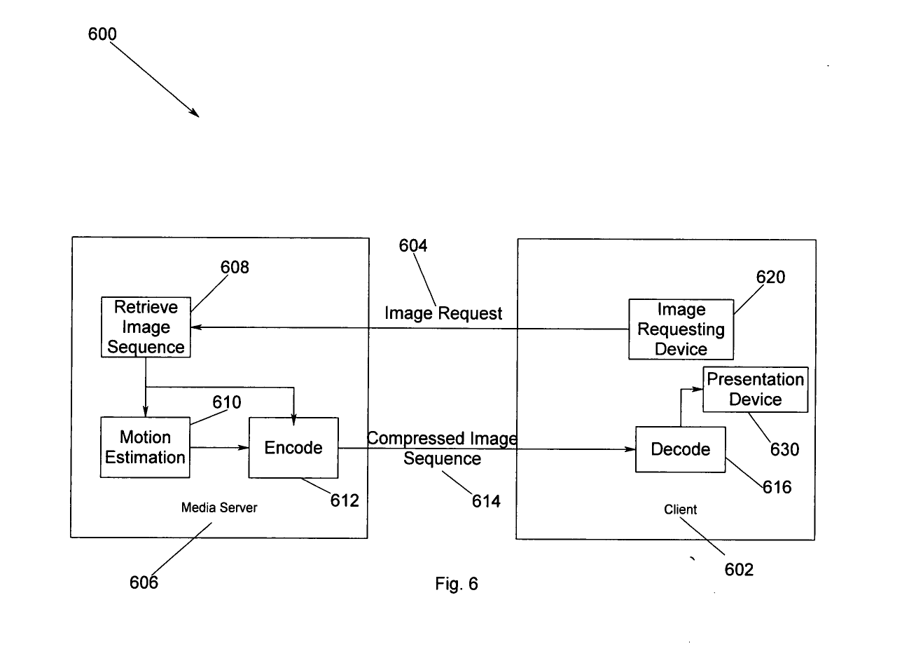

FIG. 6 is a dataflow diagram of a video compression system 600 according to various embodiments of the present invention. Within the system 600, a client 602, presenting a current frame, includes an image requesting device 620 for sending a request 604 for a new frame, for example, to a media server 606. An image sequence retrieval module 608 within a server 606 retrieves the new frame and sends the new frame contained within the current frame to a motion estimation (ME) module 610.

The ME module 610 generates one or more motion vectors (MVs) or motion paths for predicting motion in the new frame with reference to previous positions in the current frame. The ME module 610 computes these MV's using a method for simultaneously estimating multiple motion trials in video image sequences according to an embodiment of the present invention. A prediction error (PE) is then computed from each MV.

The encode module 612 within the server 606 receives the MVs and PEs from the ME module 610. The encode module 612 encodes the frames into a compressed bit-stream 614. The compressed bit-stream 614 is then transmitted to the client 602. A decoder 616 within the client 602 decodes the bit-stream into the new frame to be presented 630.

Static or video images contain regions of continuous changes and boundaries of sudden changes in color. A static image can be treated as a mapping from a 2D space to the 3D RGB color space
image: [a,b]x[c,d]→[0,255]x[0,255]x[0,255].

Similarly a video image can be treated as a mapping from 3D space to another 3D space,
video: [a,b]x[c,d]xT→[0,255]x[0,255]x[0,255].

Regression clustering is capable of automatically identifying the regions of continuous change and assigning a regression function to it, which interpolates that part of the image. Both image segmentation and interpolation (compression) may be performed using RC.

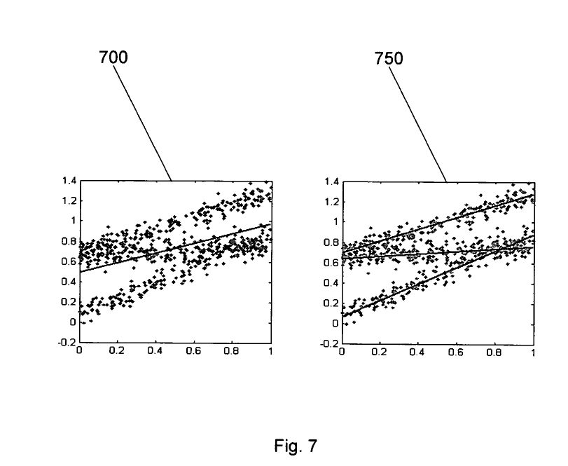

FIG. 7 illustrates two graphs 700, 750 showing a comparison between single function regression 700 and three regression functions 750, each regressed on a subset found by RC. As can be seen in FIG. 7, the residue errors are much smaller for regression clustering with the three regression functions 750.

For example, the data may be partitioned into K partitions. There have been many methods for determining the right K, i.e., the optimal number of clusters. For example, given a dataset with supervising responses, Z=(X,Y)={(xᵢ, yᵢ)|i=1, . . . , N}, a family of functions Φ={f} and a loss function e( )≧0, regression solves the following minimization problem,

$${f}^{opt} = {arg min}_{f ∈ Φ} {\sum }_{i = 1}^{N} e ( f ( {x}_{i} ) , {y}_{i} ) . \qquad ( 1 )$$

Commonly,

$$Φ = \{ {\sum }_{l = 1}^{m} {β}_{l} h ( x , {a}_{l} ) \vert {β}_{l} ∈ R , {a}_{l} ∈ {R}^{n} \} ,$$

for linear expansion of simple parametric functions such as polynomials of degree up to m, Fourier series of bounded frequency, neural networks, Radial Basis Function (RBF) techniques, etc. Further, usually, e(f(x),y)=∥f(x)−y∥^{p}, with p=1, 2 most widely used. However, equation 1 is not effective when the data set contains a mixture of very different response characteristics 700. Rather, it is much better to find the partitions in the data and learn a separate function on each partition as shown in the graph of the three regression functions 750.

In RC operations, K regression functions M={f₁, . . . , f_{K}}⊂Φ are applied to the data, which will each find its own partition Zₖ and regress on it.

$$Z = {{⋃}^{K}}_{k = 1} {Z}_{k}$$

(Zₖ∩Z_{k′}=Ø, k≠k′). Thus, the solution of the following optimization problem,

$${min}_{\{ {f}_{k} \} ; \{ {Z}_{k} \}} {Perf}_{RC \text{-} KM} = {\sum }_{k = 1}^{K} {\sum }_{( {x}_{i} , {y}_{i} ) ∈ {Z}_{k}} e ( {f}_{k} ( {x}_{i} ) , {y}_{i} ) , \qquad ( 2 )$$

optimizes both the regression functions and the partition. The optimal partition will satisfy
   Zₖ={(x, y)∈Z|e(fₖ^{opt}(x),y)≦e(f_{k′}^{opt}(x),y) ∀k′≠k}, (3)
which allows us to replace the function in equation (2) by

$${Perf}_{RC \text{-} KM} ( Z , {\{ {f}_{k} \}}_{k = 1}^{K} ) = {\sum }_{i = 1}^{N} MIN \{ e ( {f}_{k} ( {x}_{i} ) , {y}_{i} ) \vert k = 1 , … , K \} . \qquad ( 4 )$$

Accordingly, the RC-KM Operation includes picking K functions f₁⁽⁰⁾, . . . , f_{K}⁽⁰⁾∈Φ randomly, or by any heuristics that are believed to give a good start and then in the clustering phase, the database is repartitioned in the r-th iteration, r=1, 2, . . . , as:
Zₖ^{(r)}={(x,y)∈Z|e(fₖ^{(r-1)}(x),y)≦e(f_{k′}^{(r-1)}(x),y) ∀k′≠k}. (5)

A tie may be resolved randomly among the winners. Intuitively, each data point is associated with the regression function that gives the smallest approximation error on it. Algorithmically, for r>1, a data point in Zₖ^{(r-1)} is moved to Z_{k′}^{(r)} if and only if
e(f_{k′}^{(r-1)}(x),y)<e(fₖ^{(r-1)}(x),y) and a)
e(f_{k′}^{(r-1)}(x),y)≦e(f_{k″}^{(r-1)}(x),y) for all k″≠k, k′. b)

Zₖ^{(r)} inherits all the data points in Zₖ^{(r-1)} that are not moved. In the regression phase, any regression optimization operation that gives the following

$${f}_{k}^{( r )} = {arg min}_{f ∈ Φ} {\sum }_{( {x}_{i} , {y}_{i} ) ∈ {Z}_{k}} e ( f ( {x}_{i} ) , {y}_{i} ) \qquad ( 6 )$$

for k=1, . . . , K is run. The regression operation is selected by the nature of the original problem or other criteria. RC adds no additional constraint on its selection. The clustering phase and the regression phase are repeatedly until there are no more data points changing its membership. The clustering phase and the regression phase never increase the value of the objective function in equation (2). If any data changes its membership in the second step, the objective function is strictly decreased. Therefore, the operation stops in finite number of iterations. Variable selections, regularization, and/or boosting techniques may also be used with the regression on each subset independently. As mentioned earlier, mean square error linear regression with K-Means clustering may also be used.

Nevertheless, K-Means clustering operations are known to be sensitive to the initialization of its centers due to its “hard” partitioning of the data set. Since the same partitioning policy is used by the RC-KM, it is also sensitive to initialization. Further, as described above, previous regression clustering method that used K-Means and EM demonstrated the same problem of convergence being sensitive to initialization, which is a well-known problem of the K-Means and EM clustering operations.

In contrast to previous regression clustering methods, embodiments of the present invention use the K-Harmonic Means clustering operation, which demonstrates very strong insensitivity to initialization due to its dynamic weighting of the data points and its non-partitioning membership function.

RC-KHMₚ's objective function is defined by replacing the MIN( ) function in equation (4) by harmonic average HA( ), and the error function is
e(fₖ(xᵢ),yᵢ)=∥fₖ(xᵢ)−yᵢ∥^{p}

$$\begin{matrix}{Perf}_{RC \text{-} {KHM}_{p}} ( Z , M ) = {\sum }_{i = 1}^{N} HA \{ {‖ {f}_{k} ( {x}_{i} ) - {y}_{i} ‖}^{p} \vert k = 1 , … , K \} \\ = {\sum }_{i = 1}^{N} \frac{K}{{\sum }_{k = 1}^{K} \frac{1}{{‖ {f}_{k} ( {x}_{i} ) - {y}_{i} ‖}^{p}}}\end{matrix} \qquad ( 9 )$$

In the last step of equation (9), L^{p} is used instead of L². An iterative operation is then used for finding a local optimum of equation (9). First, K functions f₁⁽⁰⁾, . . . , f_{K}⁽⁰⁾∈Φ are selected. In the clustering phase, in the r-th iteration, let
d_{i,k}=∥fₖ^{(r-1)}(xᵢ)=yᵢ∥. (10)

The hard partition

$$Z = {{⋃}^{K}}_{k = 1} {Z}_{k} ,$$

in RC-KM, is replaced by a “soft” membership function, i.e., the i -th data point is associated with the k-th regression function with the probability

$$p ( {Z}_{k} \vert {z}_{i} ) = {d}_{i , k}^{p + q} / {\sum }_{l = 1}^{K} {d}_{i , l}^{p + q} . \qquad ( 11 )$$

The choice of q will put the regression's error function in L^{q}-space. For simpler notations, p(Zₖ|zᵢ) and aₚ(zᵢ) in equation (12) are not indexed by q. Quantities d_{i,k},p(Zₖ|zᵢ), and aₚ(zᵢ) should be indexed by the iteration r, which is also dropped. In RC-KHM, not all data points fully participate in all iterations like in RC-KM. Each data point's participation is weighted by

$${a}_{p} ( {z}_{i} ) = {\sum }_{l = 1}^{K} {d}_{i , l}^{p + q} / {\sum }_{l = 1}^{K} {d}_{i , l}^{p} . \qquad ( 12 )$$

where aₚ(zᵢ) is small if and only if zᵢ is close to one of the functions. Weighting function aₚ(zᵢ) changes in each iteration as the regression functions are updated. If all functions drifted away from a point zᵢ in the last iteration, aₚ(zᵢ) goes up.

In the regression phase, any regression optimization operation that gives the following

$${f}_{k}^{( r )} = {arg min}_{f ∈ Φ} {\sum }_{i = 1}^{N} {a}_{p} ( {z}_{i} ) p ( {Z}_{k} \vert {z}_{i} ) {‖ f ( {x}_{i} ) - {y}_{i} ‖}^{q} \qquad ( 13 )$$

for k=1, . . . , K is run. Since there is no discrete membership change in RC-KHM, the stopping rule is replaced by measuring the changes to its objective function of equation (9), when the change is smaller than a threshold, the iteration is stopped.

For linear regression, q has been chosen to be equal to 2. However, other values of q may also be used. Equation (13) may then be rewritten in matrix form as:

$${c}_{k}^{( r )} = {arg min}_{c} {( \overline{X} * c - Y )}^{T} * {diag}_{1 \leq i \leq N} ( {a}_{p} ( {z}_{i} ) p ( {Z}_{k} \vert {z}_{i} ) * ( \overline{X} * c - Y ) \qquad ( 14 )$$

and its solution is

$${c}_{k}^{( r )} = {( {\overline{X}}^{T} * {[ {\overline{x}}_{i} / {{d}_{i , k}^{p + 2} ( {\sum }_{l = 1}^{K} \frac{1}{{d}_{i , l}^{p}} )}^{2} ]}_{Nx \overline{D}} )}^{- 1} * {\overline{X}}^{T} * {[ {\overline{y}}_{i} / {{d}_{i , k}^{p + 2} ( {\sum }_{l = 1}^{K} \frac{1}{{d}_{i , l}^{p}} )}^{2} ]}_{Nx \overline{D}} , \qquad ( 15 )$$
where d_{i,k}=∥\overline{x}ᵢ*cₖ^{(r-1)}−yᵢ∥. ([α]_{Nx\overline{D}} is a matrix of size Nx\overline{D} with entries α being one of three possibilities: row vectors, column vectors or scalars.)

Thus, clustering recovers a discrete estimation of the missing part of the responses and provides each regression function with the correct subset of data. The performance of LinReg-KHM increases over LinReg-EM and LinReg-KM as K and D becomes larger. In the general form of RC's, the regression part of the operation is completely general, and the RC operation adds no requirement to it. This implies that RC. operations work with any type of regression and that RC operations can be built on top of existing regression libraries and the existing regression program may be called as a subroutine. Regression helps understanding the data by replacing it with an analytical function plus a residue noise. When the noise is small, the function describes the data well. However, RC does a much better job on this. The compact representation of data by a regression function can also be considered as (or part of) data compression. With a significantly smaller mean residue noise, RC does a much better job on this also.

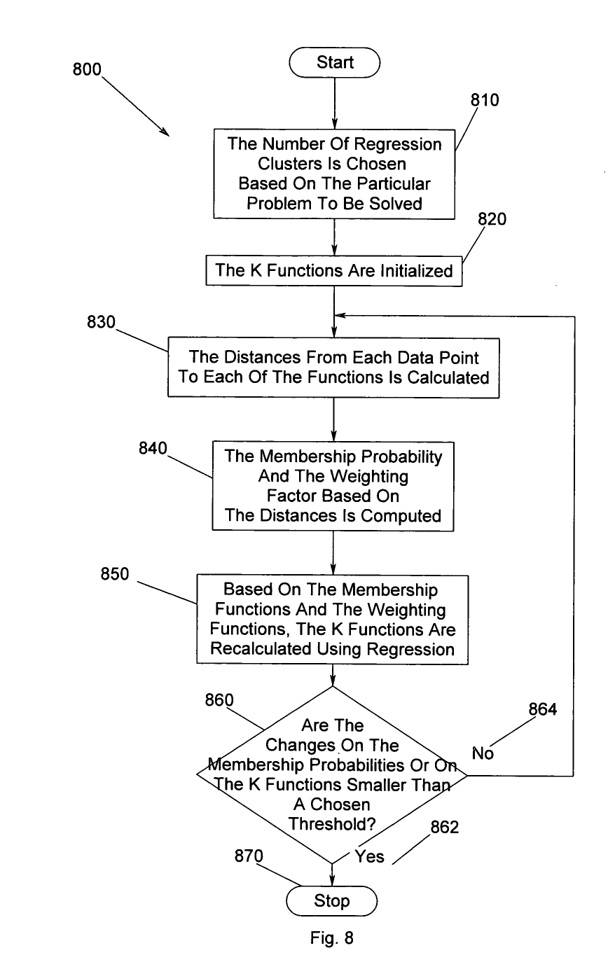

FIG. 8 is a flow chart 800 of the operations for simultaneously estimating multiple motion trials in video image sequences according to various embodiments of the present invention. In FIG. 8, first, the parameter K, i.e., the number of regression clusters, is chosen based on the particular problem to be solved 810. This selection may also be based on the users' domain knowledge. The K functions are initialized 820. For example, the K functions may be initialized randomly or based on any heuristic that is believed to be good. The distances from each data point to each of the functions is calculated 830. The membership probability and the weighting factor based on the distances are computed 840. This is the “clustering phase”. Based on the membership functions and the weighting functions, the K functions are recalculated using regression 850. The change that occurred in the iteration is checked to determine whether the changes on the membership probabilities or on the K functions are smaller than a chosen threshold 860. If the changes on the membership probabilities or on the K functions are smaller than a chosen threshold 862, then the process is stopped 870. If the changes on the membership probabilities or on the K functions are not smaller than a chosen threshold 864, the process returns to calculate the distances from each data point to each of the functions 830.

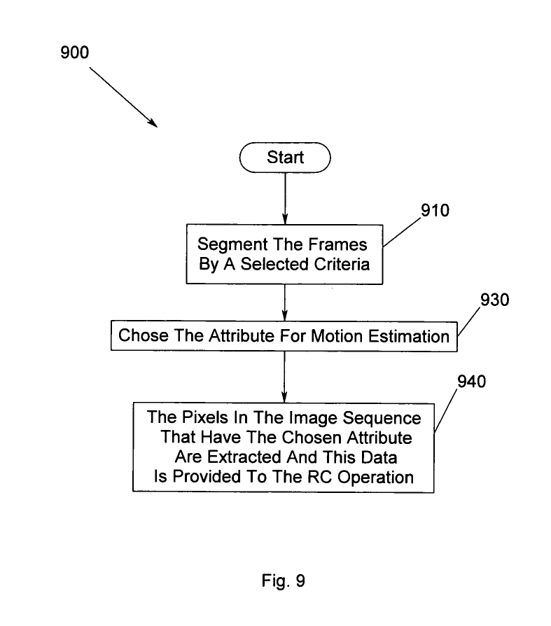

FIG. 9 is a flow chart 900 of the operations for preparing the data for processing according to various embodiments of the present invention. The frames may be segmented by, for example, color 910. However, other criteria may be used. The color (or any other attribute values) for motion estimation is chosen 930. The pixels, (time, x_coord, y_coord), in the image sequence that have the chosen color are extracted and this data is provided to the RC operation 940. If multiple colors are chosen, a (time, x_coord, y_coord, color) system may be used.

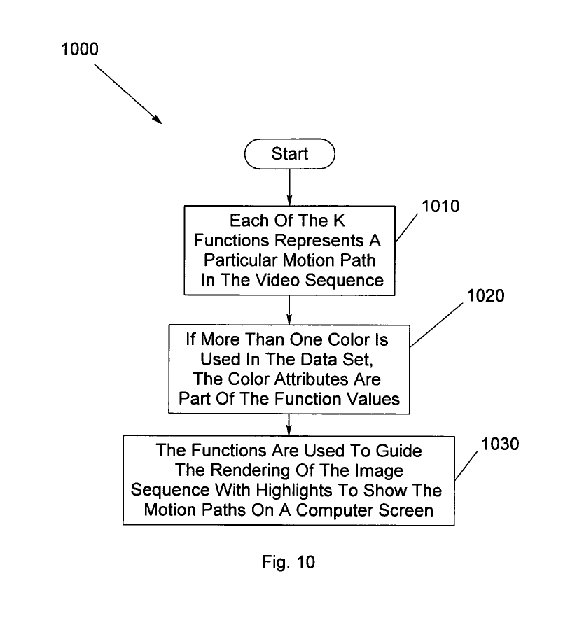

FIG. 10 illustrates additional operations 1000 when the changes on the membership probabilities or on the K functions are smaller than a chosen threshold according to various embodiments of the present invention. Each of the K functions
(x,y)=(f_{k,x}(t),f_{k,y}(t)),k=1, . . . ,K
(x,y,color)=(f_{k,x}(t),f_{k,y}(t)),k=1, . . . ,K
represents a particular motion path in the video sequence 1010. If more than one color is used in the data set, the color attributes are part of the function values 1020. These functions are used to guide the rendering of the image sequence with highlights to show the motion paths on a computer screen 1030.

The process illustrated with reference to FIGS. 1-10 may be tangibly embodied in a processor-readable medium or carrier, e.g. one or more of the fixed and/or removable data storage devices 588 illustrated in FIG. 5, or other data storage or data communications devices. The program 590 may be loaded into memory 530 to configure the processor 510 for execution of the program 590. The program 590 include instructions which, when read and executed by a processor 510 of FIG. 5, causes the devices to perform the steps necessary to execute the steps or elements of an embodiment of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A program storage device, comprising:
program instructions executable by a processing device to perform operations for estimating motion trials in video image sequences, the operations comprising:
providing data points representing information from an image sequence; and
performing regression clustering using a K-Harmonic Means function to cluster the data points and to provide motion information regarding the data points.

2. The program storage device of claim 1, wherein the performing regression clustering using the K-Harmonic Means function to cluster the data points and to provide motion information regarding the data points further comprises providing motion vectors for the data points.

3. The program storage device of claim 1, wherein the performing regression clustering using the K-Harmonic Means function to cluster the data points and to provide motion information regarding the data points further comprises providing at least one motion path for the data points.

4. The program storage device of claim 1, wherein the performing regression clustering further comprises:
selecting a number of regression clusters, K, for data points from an image sequence;
initializing regression functions for each of the K clusters to estimate the centers of motion for the data points;
calculating the distances from each data point to each of the K regression functions;
calculating a membership probability and a weighting factor for each data point based on distances between the K regression functions and each data point;
applying regression clustering using a K-Harmonic Means function to recalculate the K regression functions;
comparing a change in membership probability and a change in the K regression function to a predetermined threshold; and
using motion paths represented by the K regression functions when the change in membership probability and change in the K regression function are less than a predetermined threshold.

5. The program storage device of claim 4, wherein the initializing regression functions for each of the K clusters further comprises randomly initializing regression functions for each of the K clusters.

6. The program storage device of claim 4, wherein the program instructions further include instructions for performing the operations comprising repeating the calculating the distances, the calculating membership probability and weighting factors, and applying regression clustering until the change in membership probability and change in the K regression function is not less than the predetermined threshold.

7. The program storage device of claim 4, wherein the weighting factor is chosen to allow the K regression functions to be optimized with less sensitivity to initialization of the K regression functions.

8. The program storage device of claim 4 further comprising extracting data according to a predetermined criteria to provide the data points.

9. The program storage device of claim 8, wherein the extracting data according to the criteria comprises portioning data according to color.

10. The program storage device of claim 4, wherein the program instructions further include instructions for performing the operations comprising preparing each of the data points as x-y-coordinate data points.

11. The program storage device of claim 4, wherein the program instructions further include instructions for performing the operations comprising using the K regression functions to render the image sequence with motion paths shown on a display.

12. The program storage device of claim 11, wherein the using the K regression functions to render the image sequence further comprises overlaying the K regression functions on the video images to show motion between the image sequences.

13. A system for estimating motion trials in video image sequences, comprising:
an image sequence retrieval module for retrieving a current image and a first reference image and providing data points representing information from the current image and the first reference image; and
a motion estimator, coupled to the image sequence retrieval module, for performing regression clustering using a K-Harmonic Means function to cluster the data points and to provide motion information regarding the data points.

14. The system of claim 13, wherein the motion information regarding the data points further comprises motion vectors for the data points.

15. The system of claim 13, wherein the motion information regarding the data points further comprises at least one motion path for the data points.

16. The system of claim 13, wherein the motion estimator performs regression clustering by selecting a number of regression clusters, K, for data points from an image sequence, initializing regression functions for each of the K clusters to estimate the centers of motion for the data points, calculating the distances from each data point to each of the K regression functions, calculating a membership probability and a weighting factor for each data point based on distances between the K regression functions and each data point, applying regression clustering using a K-Harmonic Means function to recalculate the K regression functions, comparing a change in membership probability and a change in the K regression functions to a predetermined threshold and using motion paths represented by the K regression functions when the change in membership probability and change in the K regression function are less than a predetermined threshold.

17. The system of claim 16, wherein the motion estimator randomly initializes regression functions for each of the K clusters.

18. The system of claim 16, wherein the motion estimator repeats the calculation of the distances, the membership probability and weighting factors, and applies regression clustering until the change in membership probability and change in the K regression function is not less than the predetermined threshold.

19. The system of claim 16, wherein the weighting factor is chosen to allow the K functions to be optimized with less sensitivity to initialization of the K regression functions.

20. The system of claim 16, wherein the motion estimator extracts data according to predetermined criteria.

21. The system of claim 20, wherein the motion estimator extracts data according to color.

22. The system of claim 16, wherein the image sequence retrieval module prepares each of the data points as x-y-coordinate data points.

23. The system of claim 16 further comprising a processor for using the K regression functions to render the image sequence with motion paths shown on a display.

24. The system of claim 23, wherein the processor overlays the K regression functions on the video images to show motion between the current image and the first reference image.

25. A method for estimating motion trials in video image sequences, the method comprising:
providing data points representing information from an image sequence; and
performing regression clustering using a K-Harmonic Means function to cluster the data points and to provide motion information regarding the data points.

26. The method of claim 25, wherein the performing regression clustering further comprises:
selecting a number of regression clusters, K, for data points from an image sequence;
initializing regression functions for each of the K clusters to estimate the centers of motion for the data points;
calculating the distances from each data point to each of the K regression functions;
calculating a membership probability and a weighting factor for each data point based on distances between the K regression functions and each data point;
applying regression clustering using a K-Harmonic Means function to recalculate the K regression functions;
comparing a change in membership probability and a change in the K regression functions to a predetermined threshold; and
using motion paths represented by the K regression functions when the change in membership probability and change in the K regression functions are less than a predetermined threshold.

27. A system for estimating motion trials in video image sequences, comprising:
means for retrieving a current image and a first reference image and providing data points representing information from the current image and the first reference image; and
means for performing regression clustering, coupled to the means for retrieving and providing, wherein the means for performing regression clustering uses a K-Harmonic Means function to cluster the data points and to provide motion information regarding the data points.

28. The system of claim 27, wherein the means for performing regression clustering further comprises means for selecting a number of regression clusters, K, for data points from an image sequence, means for initializing regression functions for each of the K clusters to estimate the centers of motion for the data points, means for calculating the distances from each data point to each of the K regression functions, means for calculating a membership probability and a weighting factor for each data point based on distances between the K regression functions and each data point, means for applying regression clustering using a K-Harmonic Means function to recalculate the K regression functions, means for comparing a change in membership probability and a change in the K regression functions to a predetermined threshold and means for using motion paths represented by the K regression functions when the change in membership probability and change in the K regression functions are less than a predetermined threshold.

29. A system for estimating motion trials in video image sequences, comprising:
means for storing a current image and a first reference image;
means, coupled to the means for storing, for retrieving and providing data points representing information from the current image and the first reference image; and
means, coupled to the means for retrieving, for performing regression clustering using a K-Harmonic Means function to cluster the data points and to provide motion information regarding the data points.

30. The system of claim 29, wherein the means for performing regression clustering further comprises:
means for selecting a number of regression clusters, K, for data points from an image sequence,
means for initializing regression functions for each of the K clusters to estimate the centers of motion for the data points,
means for calculating the distances from each data point to each of the K regression functions,
means for calculating a membership probability and a weighting factor for each data point based on distances between the K regression functions and each data point,
means for applying regression clustering using a K-Harmonic Means function to recalculate the K regression functions,
means for comparing a change in membership probability and a change in the K regression functions to a predetermined threshold; and
means for using motion paths represented by the K regression functions when the change in membership probability and change in the K regression functions are less than a predetermined threshold.
